(19) United States
(12) Patent Application Publication
(10) Pub. No.: US 2005/0068476 A1
(43) Pub. Date: Mar. 31, 2005

(54) Polarizing plate, liquid crystal display using the same and method for manufacturing polarizing plate

(76) Inventor: Masato Okabe, Tokyo (JP)

Correspondence Address: SEYFARTH SHAW, 55 EAST MONROE STREET, SUITE 4200, CHICAGO, IL, 60603-5803, US

(21) Appl. No.: 10/853,305

(22) Filed: May 25, 2004

(30) Foreign Application Priority Data
May 26, 2003 (JP) 2003-147899

(51) Int. Cl. G02F 1/1335

(52) U.S. Cl. 349/96

(57) ABSTRACT

A main object of the present invention is to provide a polarizing plate having a good polarization performance, capable of being reduced in thickness, and showing excellent manufacturing efficiency. To attain the above mentioned object, the present invention provides a polarizing plate comprising: a base material; a resin layer formed on the base material and having concave portions or convex portions formed in a pattern on its surface; and a polarizing layer formed on the resin layer and comprising a tabular dye.

### BACKGROUND OF THE INVENTION

1. Field of the Invention

The present invention relates to a polarizing plate that can be used in liquid crystal displays and the like, and a method for manufacturing the same.

2. Description of the Related Art

Recently, liquid crystal displays have showed remarkable development as a display for various displays. With decreasing of the thickness of this liquid crystal display, there are also various requirements for polarizing plates used in liquid crystal displays, such as decrease in film thickness, improvement in manufacturing efficiency and the like.

As conventionally generally used polarizing plates, those obtained by uniaxially orienting a polyvinyl alcohol based resin film and allowing iodine or dichromatic direct dye and the like to be adsorbed and aligned on its surface are mentioned. For the purpose of imparting strength, protecting from water, and the like, a transparent protective film such as a triacetylcellulose film and the like is pasted on the both surfaces of the polarizing plate and the obtained laminate is used.

However, in the above mentioned polarizing plate, there is a problem that the film thickness is difficult to be reduced since a film after orientation usually has a thickness of about 30 μm.

For solving such a problem, for example, a polarizing plate is suggested. The suggested polarizing plate is obtained by: subjecting a base material to a rubbing treatment; carrying out a corona treatment on this; coating a dichromatic direct dye on this; and aligning the above mentioned dichromatic direct dye along the rubbing direction, thereby forming a polarizing layer (JP-A No. 3-54506). However, polarizing performance of a polarizing plate obtained by the above mentioned method and the like is insufficient and is not put into practical use. Therefore, there is a desire for further improvement in transmittance and contrast.

### SUMMARY OF THE INVENTION

Based on the above mentioned conditions, it is desired to provide a polarizing plate having a good polarization performance, capable of being reduced in thickness, and showing excellent manufacturing efficiency.

To attain the above mentioned object, the present invention provides a polarizing plate comprising: a base material; a resin layer formed on the base material and having concave portions or convex portions formed in a pattern on its surface; and a polarizing layer formed on the resin layer and comprising a tabular dye.

In the present invention, since a resin layer having concave portions or convex portions is formed, by coating the above mentioned polarizing layer forming coating solution containing a tabular dye on the above mentioned resin layer, the above mentioned tabular dye can be easily aligned along a certain direction by utilizing a pattern of the concave portion on the surface of the resin layer. Thus, a polarizing layer can be obtained. Since a polarizing layer can be formed without orienting a base material and the like, the thickness of a polarizing plate can be thinner, and a polarizing plate can be manufactured with a high efficiency.

In the present invention, it is preferable that the tabular dye is a dye selected from a group consisting of an anthraquinone based dye, a phthalocyanine based dye, a porphyrin based dye, a naphthalocyanine based dye, a quinacridone based dye, a dioxazine based dye, an indanethrene based dye, an acridine based dye, a perylene based dye, a pyrazolone based dye, an acridone based dye, a pyranthrone based dye and an isoviolanthrone based dye. The reason for this is that these tabular dyes have light absorption anisotropy in the visible light region.

Moreover, in the present invention, it is preferable that the tabular dyes form a column structure, which is a lamination of the tabular dyes whose normal line directions are faced to a certain direction of the base material, and the column structure is aligned along the concave portion of the resin layer. The reason for this is that since a column structure composed of tabular dyes is aligned along the concave portion of the resin layer, a polarizing layer having a good polarization property and an excellent heat resistance can be easily formed.

Further, in the present invention, it is preferable that the tabular dye shows a lyotropic liquid crystal phase in a solution. The reason for this is that since the above mentioned tabular dye forms a column structure by self-assembly and show a lyotropic liquid crystal phase in a solution, a column structure can be easily aligned by coating polarizing layer forming coating solution containing such a tabular dye.

Further, in the present invention, it is preferable that a hydrophilic treatment is performed on a surface of the resin layer. The reason for this is that when such convex-concave structure is duplicated, there is usually a possibility that the formed surface has higher water repellency and tabular dyes are not aligned successfully.

The present invention also provides a liquid crystal display obtained by laminating the above mentioned polarizing plate and a liquid crystal cell. In the present invention, by using the above mentioned polarizing plate, the thickness of a liquid crystal display can be thinner, and a liquid crystal display preferable in a manufacturing efficiency and cost can be obtained.

Moreover, the present invention provides a method for manufacturing a polarizing plate comprising a resin layer forming process of forming a resin layer by carrying out: a coating process of coating a curing resin composition on a base material or on a concave portion forming substrate, having convex portions formed in a pattern on its surface; a disposing process of laminating the base material and the concave portion forming substrate with sandwiching the curing resin composition; a curing process of curing the curing resin composition to obtain a curing resin; and a concave portion forming process of forming the concave portion in a pattern by peeling the concave portion forming substrate from the curing resin composition or from the curing resin; and

a polarizing layer forming process of forming a polarizing layer by carrying out: a coated film forming process of forming a coated film by coating a polarizing layer forming coating solution, on the resin layer, comprising a tabular dye and aligning the tabular dye by the concave portions of the resin layer; a drying process of drying the coated film; and a fixing process of fixing the aligned condition of the tabular dye.

In the present invention, for example, by curing resin composition which is sandwiched between the above mentioned concave portion forming substrate, having convex portions, and a base material, a resin layer having concave portions formed in a pattern on its surface can be formed. Subsequently, by coating the above mentioned polarizing layer forming coating solution containing a tabular dye on this resin layer, a tabular dye can be aligned along a certain direction by the pattern of the above mentioned concave portion. Thus, a polarizing layer can be obtained. By this, a polarizing plate can be manufactured efficiently without limitation of the kind and thickness of a base material.

In the above mentioned present invention, it is preferable that the tabular dyes form a column structure, which is a lamination of the tabular dyes whose normal line directions are faced to a certain direction of the base material,

show a lyotropic liquid crystal phase in the polarizing layer forming coating solution, and

the column structure is aligned along the concave portion of the resin layer. The reason for this is that since such tabular dyes form a column structure by self-assembly and show a lyotropic liquid crystal phase in a solution, a column structure can be easily aligned along the concave portion of the resin layer by coating this polarizing layer forming coating solution containing tabular dyes.

In the present invention, it is preferable that a coating method, in which a shearing stress is not applied to the polarizing layer forming coating solution, is used in the coated film forming process in the polarizing layer forming process. The reason for this is that when a coating method which applies a shearing stress is used, there is a possibility that the tabular dyes are aligned along the coating direction and it may be difficult to align by the concave portion of the resin layer.

Further in the present invention, it is preferable that a method for cross-linking the tabular dye is used in the fixing process of the polarizing layer forming process. The reason for this is that by cross-linking the above mentioned tabular dye, a polarizing layer showing high polarization and excellent heat resistance can be formed.

Still further, in the present invention, it is preferable that a hydrophilic treatment process of making the surface of the resin layer having concave portions formed thereon hydrophilic, is carried out after the resin layer forming process. The reason for this is that when such a resin layer forming process is carried out, the surface of the formed resin layer usually manifests high water repellency and the liquid crystal may not be aligned successfully.

### BRIEF DESCRIPTION OF THE DRAWINGS

FIG. 1 is a schematic sectional view showing one example of the polarizing plate of the present invention.

FIG. 2 is a schematic sectional view showing one example of a shape of a resin layer used in the present invention.

FIG. 3 is an explanatory view explaining a tabular dye.

FIGS. 4A, 4B, 4C, 4D, and 4E are process views showing one example of the method for manufacturing a polarizing plate of the present invention.

FIG. 5 is a process view showing one example of the curing process in the method for manufacturing a polarizing plate of the present invention.

FIG. 6 is a process view showing another example of the curing process in the method for manufacturing a polarizing plate of the present invention.

### DESCRIPTION OF THE PREFERRED EMBODIMENT

The present invention relates to a polarizing plate which can be used in liquid crystal displays and the like, a liquid crystal display using this polarizing plate, and a method for manufacturing a polarizing plate. These will be explained below.

A. Polarizing plate

First, the polarizing plate of the present invention will be explained. The polarizing plate of the present invention comprises: a base material; a resin layer formed on the base material and having concave portions or convex portions formed in a pattern on its surface; and a polarizing layer formed on the resin layer and comprising a tabular dye.

The polarizing plate of the present invention will be explained referring to drawings. FIG. 1 is a schematic sectional view showing one example of the polarizing plate of the present invention. As shown in FIG. 1, the polarizing plate of the present invention comprises a base material 1, a resin layer 2 formed on this base material 1 and having concave portions or convex portions formed in a pattern on its surface, and a polarizing layer 3 formed on this resin layer 2 and comprising a tabular dye.

In the present invention, since a resin layer having concave portions or convex portions is formed, for example, by coating the above mentioned polarizing layer forming coating solution comprising tabular dyes is coated on this resin layer, the above mentioned tabular dyes can be aligned along a certain direction easily by convex-concave on the surface. Therefore, since it is not necessary to orient the base material when forming the above mentioned polarizing layer the thickness of the polarizing plate is not influenced by the thickness of the base material, can be thinner, and the kind of the base material is not limited. Moreover, since there is no limitation to the kind of the base material, various kinds of base materials can be used. By this, it is possible to impart various properties such as strength, durability and the like to the polarizing plate. Furthermore, since a polarizing layer can be formed by coating the above mentioned polarizing layer forming coating solution, the polarizing plate can be manufactured efficiently.

Constitutions of such a polarizing layer of the present invention will be explained below.

1. Resin Layer

First, the resin layer used in the present invention will be explained. The resin layer used in the present invention is formed on a base material described later and has concave portions or convex portions formed in a pattern on its surface. In the present invention, since the resin layer has concave portions or convex portions, by coating polarizing layer forming coating solution comprising tabular dyes, the tabular dyes can be aligned along a certain direction by the pattern of the concave portions, to obtain the polarizing layer described later.

The shape of the pattern of concave portions or convex portions of the resin layer in the present invention is not particularly limited as long as this shape can be a layer having polarization property when the tabular dyes are aligned. Particularly, a pattern of stripes regularly formed with a certain clearance is preferable. The reason for this is that the tabular dyes can be aligned easily by concave portions in the form of stripes.

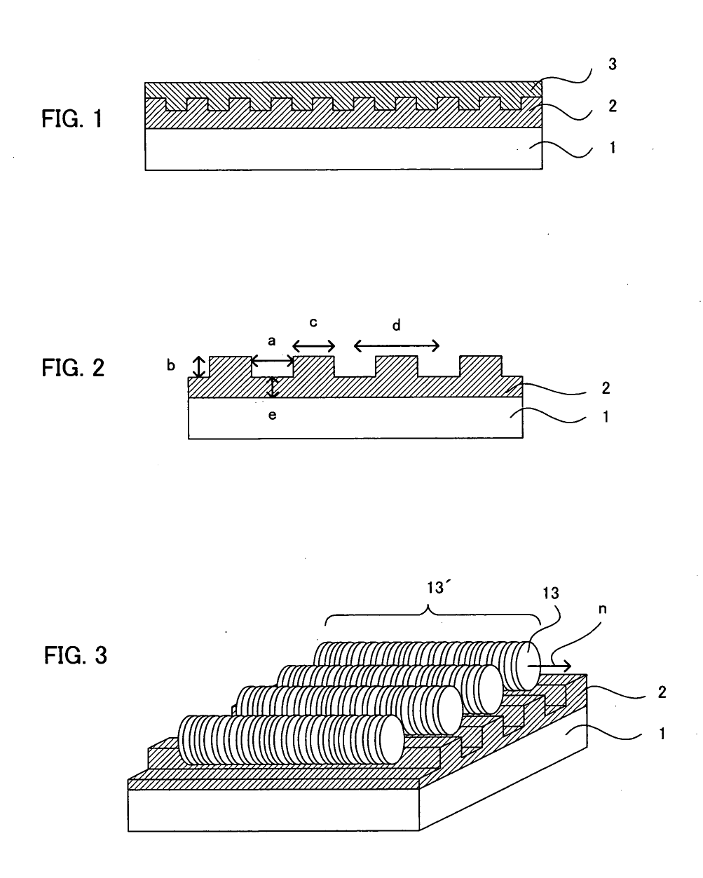

In the present invention, the width of such concave portions differs depending on the kind of the tabular dye described in the paragraph of a polarizing layer described later. However, the width is usually in a range of 0.1 μm to 100 μm, preferably in a range of 0.1 μm to 10 μm, particularly in a range of 0.2 μm to 1 μm. The reason for this is that it is difficult, from the standpoint of manufacturing method, to set the width of concave portions narrower than the above mentioned range. In contrast, when the width of concave portions is too large, it is difficult to align a column structure composed of the tabular dyes in some cases. Here, the width of the concave portions is, for example, a width shown by “a” in FIG. 2, meaning the width of a part in the form of concave.

It is preferable that the depth of the concave portions is usually in a range of 0.05 μm to 1 μm, particularly in a range of 0.1 μm to 0.2 μn. The reason for this is that when the depth of the concave portions is too small, an ability of aligning the column structure composed of the tabular dyes lowers. In contrast, when the depth of the concave portions is too large, there is a possibility of occurrence of coating unevenness in coating the polarizing layer forming coating solution containing the tabular dye on the resin layer. Here, the depth of concave portions is, for example, a depth represented by “b” in FIG. 2, meaning a height from the deepest part of a concave portion to the end part of the concave portion.

Further, when the pattern of the concave portions or convex portions is stripe, a interval of the concave portions differs depending on the kind of the below mentioned tabular dye. Usually, it is a distance between the ends of adjacent concave portions, that is, the width of the convex portion is a half or less of the wavelength of visual light, preferably in a range of 0.05 μm to 2μm, more preferably in a range of 0.1 μm to 1 μm, particularly in a range of 0.1 μto 0.2 μm. The reason for this is that it is difficult, from the standpoint of manufacturing method, to set the interval between the ends of adjacent concave portions narrower than the above mentioned range. In contrast, when the distance between the ends of adjacent concave portions is too large, it is difficult to align the column structure composed of the tabular dyes in some cases. Also, the reason for this is that, when the distance between the ends of adjacent concave portions is a value close to the wavelength of visible light, there is a possibility of occurrence of failures such as optical coloration by diffraction of light and the like. Here, the distance between the ends of adjacent concave portions is, for example, a distance represented by “c” in FIG. 2.

The pitch of the concave portions is appropriately selected depending on the kind of the below mentioned tabular dye and the like, and usually, in a range of 0.1 μm to 10μm, more preferably in a range of 0.2 μm to 1 μm, particularly in a range of 0.2 μm to 0.4 μm. The reason for this is that it is difficult, from the standpoint of manufacturing method, to set the pitch of concave portions narrower than the above mentioned range. In contrast, when the pitch of the concave portions is too large, it is difficult to align the column structure composed of the tabular dyes in some cases. Here, the pitch of the concave portions is, for example, a pitch represented by “d” in FIG. 2, meaning a distance from the center of a concave portion to the center of an adjacent concave portion.

The sectional shape of the concave portions of the above mentioned resin layer is not particularly limited. For example, the sectional shape of the concave portions may be rectangular as shown in FIG. 1. Further, the sectional shape of the concave portions may be trapezoid or other shapes. In the present invention, the sectional shape of the concave portions is preferably rectangular among others since the column structure composed of the below mentioned tabular dyes can be easily aligned along a certain direction.

A resin layer having the concave portions as described above can be formed by preparing a concave portion forming substrate having convex portions, on its surface, symmetrical to the shape of the intended concave portions, sandwiching a curing resin composition between this concave portion forming substrate and a below mentioned base material, and curing the composition. As the curing resin used in such as resin composition, for example, curing resins such as unsaturated polyesters, melamine, epoxy, polyester (meth) acrylate, urethane (meth)acrylate, epoxy (meth)acrylate, polyether (meth)acrylate, polyol (meth)acrylate, melamine (meth)acrylate, triazine based acrylates and the like can be used by itself or in admixture. The above mentioned resin composition may be a thermosetting resin or an ultraviolet ray curing resin, and these resins may be combined.

Further, various additives such as curing agents, photopolymerization initiators and the like may be added, if necessary, to the above mentioned resin composition. Moreover, the viscosity thereof may be controlled by using a solvent, monomer and the like for coating on the base material described later or for pouring into between the base material described later and the above mentioned concave portion forming substrate.

The thickness of the above mentioned resin layer differs depending on the kind of the polarizing plate. The thickness of the concave portion is usually 1 μm or less, preferably 0.2 μm or less. The reason for this is that if the thickness of the concave portions is too large, there is a possibility of increase in the thickness of the polarizing plate of the present invention. Though the thickness of the concave portion is preferably thinner, when considering a decrease in the thickness of the polarizing plate, since it is difficult to form the concave portions having a thickness which is too small, the thickness of the concave portions is usually 0.1 μm or more. Here, the thickness of the concave portions means the thickness of a part, where the concave portion is formed, as represented by “e” in FIG. 2.

A method for forming the above mentioned resin layer is explained in a paragraph of “C. Method of manufacturing polarizing plate” described later. Therefore, explanations thereof are omitted here.

In the present invention, when such convex-concave structure is duplicated, there is usually a possibility that the surface of the formed resin layer manifests higher water repellency and the liquid crystal is not aligned successfully. Since the polarizing layer forming coating solution which forms the polarizing layer described later is coated on this resin layer, the above mentioned resin layer is preferably hydrophilic, and a hydrophilic layer may be provided on the above mentioned resin layer, or the surface of the above mentioned resin layer may be subjected to a hydrophilic treatment. As the method for surface treatment so as to impart lyophilic property to the surface of the above mentioned resin layer, there are lyophilic surface treatments by plasma treatment utilizing argon, water and the like. As the lyophilic layer formed on the resin layer, there are, for example, a silica membrane and the like formed by a sol gel method using tetraethoxysilane, and the like.

2. Polarizing Layer

Next, the polarizing layer used in the present invention will be explained. The polarizing layer used in the present invention is a layer comprising the tabular dyes and is not particularly limited as long as the tabular dyes are aligned along a certain direction by the pattern of the concave portions of the above mentioned resin layer.

The tabular dye used in such a polarizing layer is aligned by the concave portions of the above mentioned resin layer and is not particularly limited as long as it can form a layer having a polarization property by aligning. For example, dyes and the like selected from the group consisting of, an anthraquinone based dye, a phthalocyanine based dye, a porphilin based dye, a naphthalocyanine based dye, a quinacridone based dye, a dioxazine based dye, an indanethrene based dye, an acridine based dye, a perylene based dye, a pyrazolone based dye, an acridone based dye, a pyranethrone based dye and an isoviolanthrone basd dye can be listed.

It is preferable that the tabular dyes used in the present invention form a column structure, which is a lamination of the tabular dyes whose normal line directions are faced to a certain direction of the base material. The reason for this is that since the above mentioned column structure formed by self assembly of the tabular dyes is easily aligned to a certain direction along the concave portions of the above mentioned resin layer, the polarizing layer having a good polarization property can be obtained.

FIG. 3 is a schematic perspective view of the polarizing layer used in the present invention. As shown in FIG. 3, in this polarizing layer, tabular dyes 13 form a column structure 13′ which is a lamination of the tabular dyes 13 whose normal line directions “n” are faced to a certain direction of a base material 1, along the concave portion of the resin layer 2, and a plurality of such column structures 13′ are aligned to form the polarizing layer. In the polarizing layer constituted by aligned tabular dyes 13 as described above, since the column axis directions of a plurality of column structure 13′ are faced to a certain direction of the base material 1, a layer having a polarization property can be obtained.

Such tabular dyes are not particularly limited as long as they can form the column structure by laminating in a form of pillar. As the tabular dye capable of forming the column structure, for example, the tabular dyes having a hydrophilic group such as a sulfonic group and the like, and the tabular dyes having a hydrophobic group such as a long chain alkyl group and the like can be listed. Among them, the tabular dyes having a hydrophilic group are preferable. The reason for this is that the tabular dyes having a hydrophilic group can form the column structure easily since this hydrophilic group is small and the distance between adjacent column structures is small. Also, the reason for this is that since a hydrophilic portion of a sulfonic group and the like is neutralized to give poor solubility or insolubility in water, a fixing treatment becomes easy. Listed as the above mentioned hydrophilic group are: sulfonic acid based hydrophilic groups such as a sulfonic group, sodium sulfonate group, ammonium sulfonate group, lithium sulfonate group, potassium sulfonate group and the like; carboxylic acid based hydrophilic groups such as a carboxyl group, sodium carboxylate group, ammonium carboxylate group, lithium carboxylate group, potassium carboxylate group and the like; a hydroxyl group, amino group and the like. Among them, sulfonic acid based hydrophilic groups are preferable.

Formation of the column structure by the tabular dyes can be confirmed by measurement using an X-ray diffraction apparatus.

Among the above mentioned tabular dyes used in the present invention, those showing a lyotropic liquid crystal phase in a solution are preferable. The reason for this is that since the above mentioned tabular dyes form the column structure and show a lyotropic liquid crystal phase in a solution, by coating such polarizing layer forming coating solution comprising the above mentioned tabular dyes, the column structure can be easily aligned.

As such tabular dyes showing lyotropic liquid crystal phase in a solution, the tabular dyes showing a lyotropic liquid crystal phase in an aqueous solution or the tabular dyes showing a lyotropic liquid crystal phase in an organic solvent can be listed. The kind of the above mentioned solution differs depending on a substituent on the above mentioned tabular dye. When the tabular dye has a hydrophilic group such as a sulfonic group and the like, an aqueous solution is used. And when the tabular dye has a hydrophobic group such as a long chain alkyl group and the like, an organic solvent is used. Among them, the tabular dyes showing a lyotropic liquid crystal phase in an aqueous solution are preferably used. The reason for this is that when the above mentioned tabular dye has a hydrophilic group and shows a lyotropic liquid crystal phase in an aqueous solution, a treatment in fixing the aligned condition of the tabular dye described later becomes simple.

Specific examples of the tabular dye forming the above mentioned column structure and showing a lyotropic liquid crystal phase. in an aqueous solution include substance of the following chemical formulae. 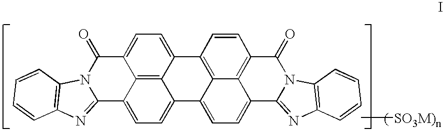
M represents a cation
n is an integer of 2 to 4 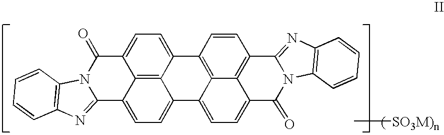
M represents a cation
n is an integer of 2 to 4 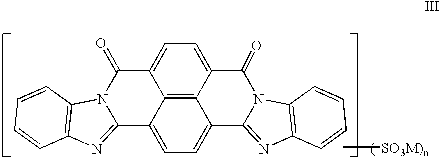
M represents a cation
n is an integer of 2 to 4 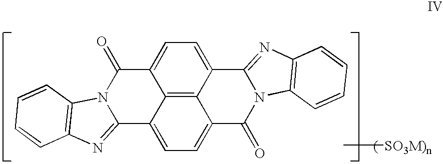
M represents a cation
n is an integer of 2 to 4 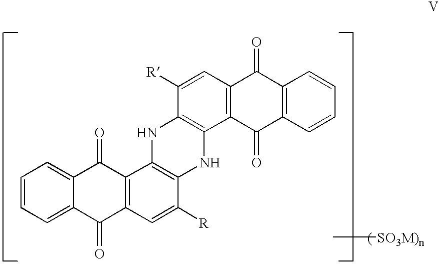
R represents H, Cl
R′ represents H, alkyl group
M represents a cation
n is an integer of 2 to 4 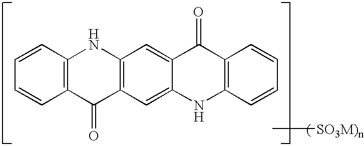
M represents a cation
n is an integer of 2 to 4 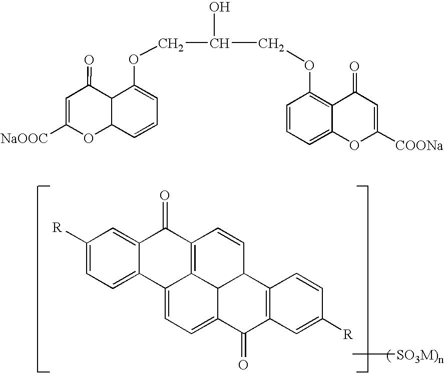
R represents H, Br, NHAr 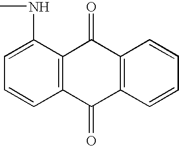
M represents a cation
n is an integer of 2 to 4 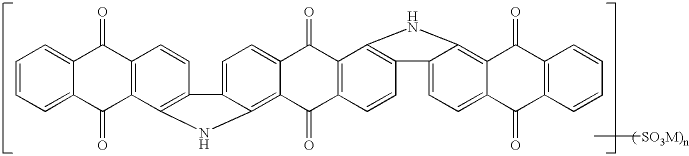
M represents a cation
n is an integer of 2 to 4 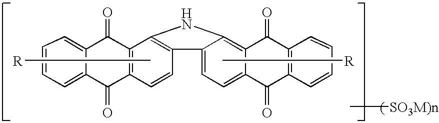
R represents H, NHCOPh
M represents a cation
n is an integer of 2 to 4 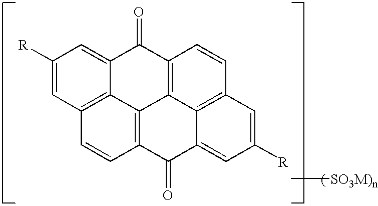
R represents H, Br, NHAr, 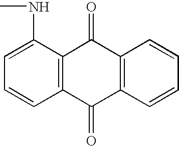
M represents a cation
n is an integer of 2 to 4 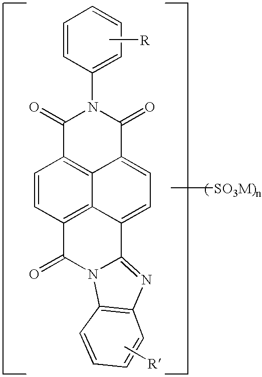
R, R′ represent H, halogen, alkyl group, alkoxy group, ArNH, OPh
M represents a cation
n is an integer of 2 to 4 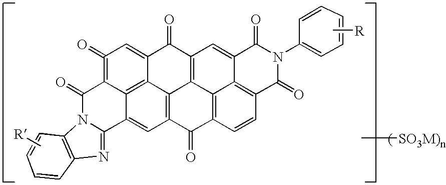
R, R′ represent H, halogen, alkyl group, alkoxy group, ArNH, OPh
M represents a cation
n is an integer of 2 to 4 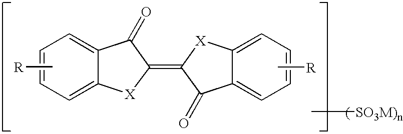
X represents NH, S
R represents halogen, alkoxy group
M represents a cation
n is an integer of 2 to 4 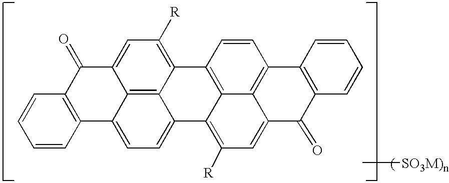
R represents H, OH, OCH₃
M represents a cation
n is an integer of 2 to 4 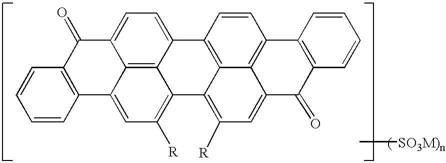
R represents H, OH, OCH₃
M represents a cation
n is an integer of 2 to 4 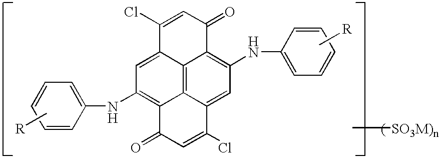
R represents H, halogen, alkyl group, alkoxy group, ArNH, OPh
M represents a cation
n is an integer of 2 to 4 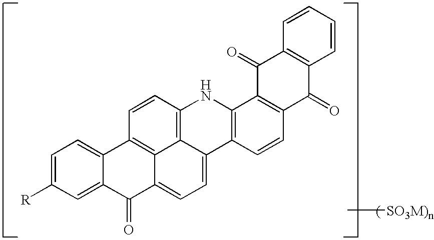
R represents H, Br, NHAr, 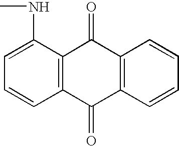
M represents a cation
n is an integer of 1 to 3 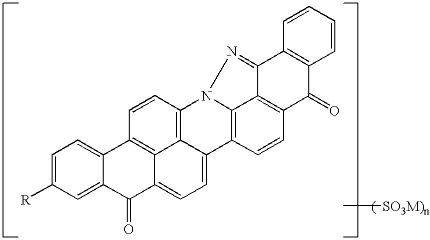
R represents H, Br, NHAr, 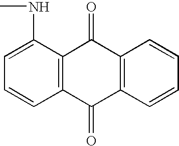
M represents a cation
n is an integer of 2 to 4 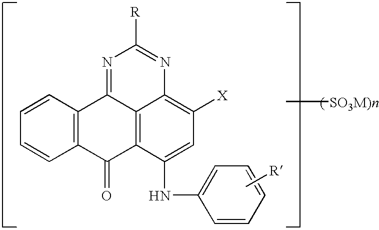
X represents H, Br, SO₃M
R represents H, alkyl group
R′ represents H, halogen, alkyl group, alkoxy group, NHPh, OPh
M represents a cation
n is an integer of 2 to 4 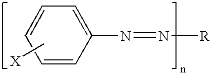
X represents COOM, PO(OM)₂
R′, R″ represent H, haogen
Y represents NH₂, OM
M represents a cation
n is 1 or 2
R represents 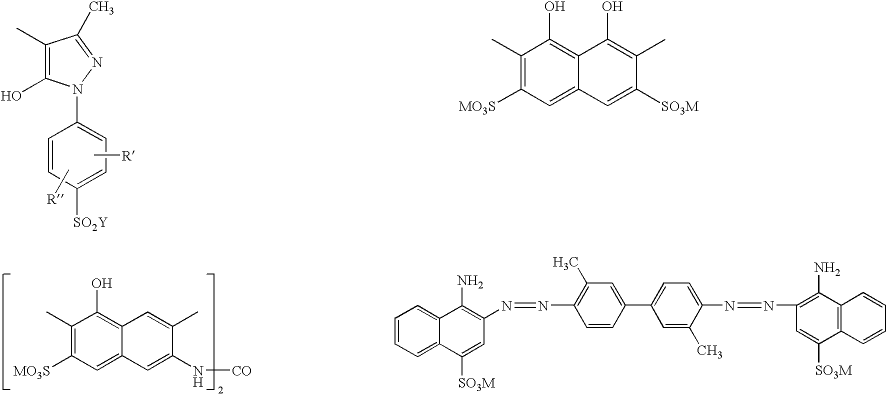
M represents a cation 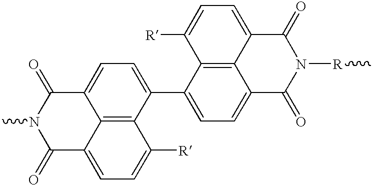
R represents 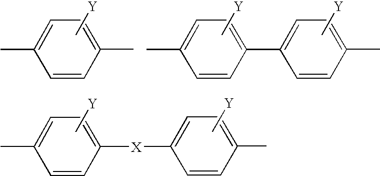
X represents O, CH₂, NH, CONH, NHCONH, CH═CH
Y represents H, CH₃, CH₃O, COOM, SO₃M
R′ represents H, NO₂, COOM, SO₃M
M represents a cation 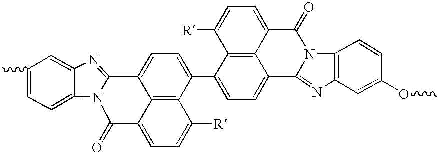
R′ represents COOM, SO₃M
M represents a cation 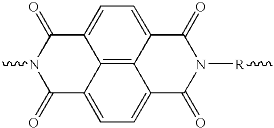
R represents 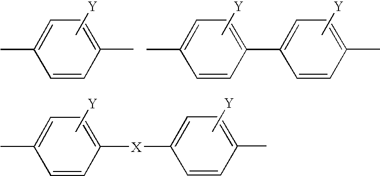
X represents O, CH₂, NH, CONH, NHCONH, CH═CH
Y represents COOM, SO₃M
M represents a cation 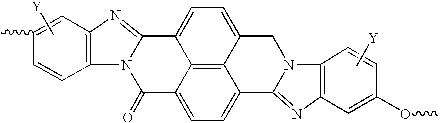
Y represents SO₃M
M represents a cation 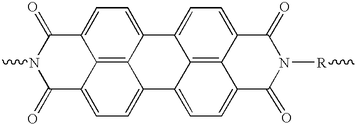
R represents 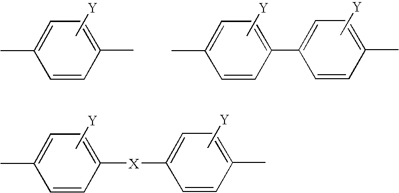
X represents O, CH₂, NH, CONH, NHCONH, CH═CH
Y represents COOM, SO₃M
M represents a cation 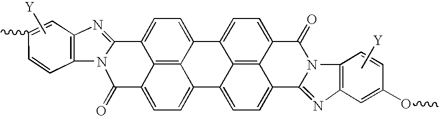
Y represents SO₃M
M represents a cation 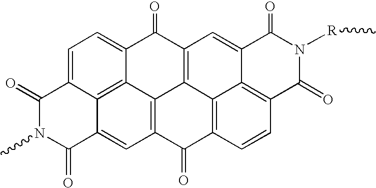
R represents 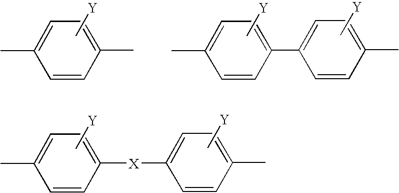
X represents O, CH₂, NH, CONH, NHCONH, CH═CH
Y represents COOM, SO₃M
M represents a cation 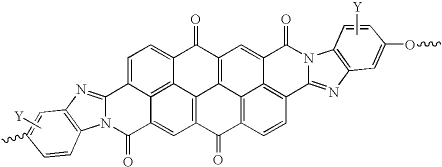
Y represents COOM, SO₃M
M represents a cation 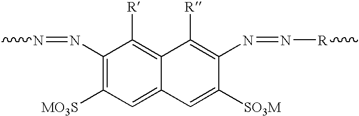
R represents 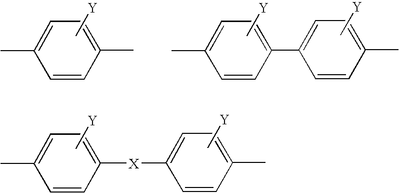
X represents O, CH₂, NH, CONH, NHCONH, CH═CH
Y represents H, CH₃, CH₃O, COOM, SO₃M
R′, R″ represent OH, NH₂
M represents a cation
   ˜A—R˜
A is any one of the following a, b, c, d, e, f, g and h
R represents 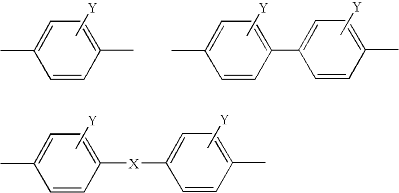
X represents O, CH₂, NH, CONH, NHCONH, CH═CH
Y represents COOM, SO₃M
M represents a cation 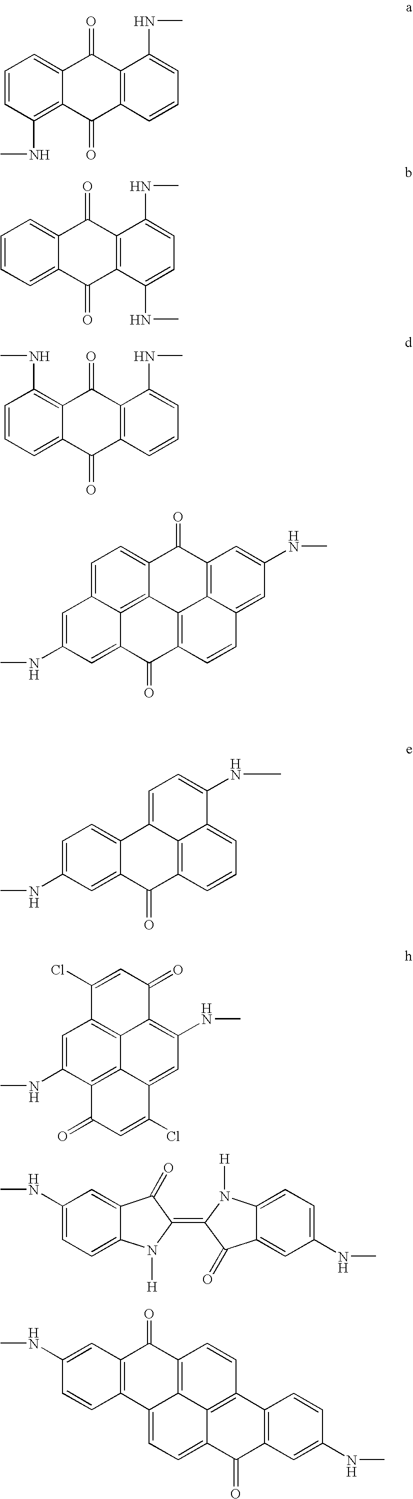 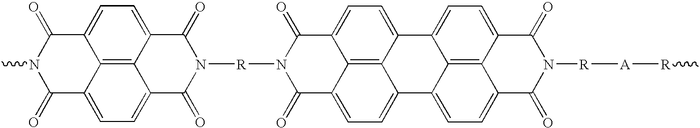
A is any one of the following a, b, c, d, e, f, g and h
R represents 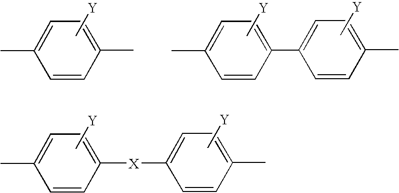
X represents O, CH₂, NH, CONH, NHCONH, CH═CH
Y represents COOM, SO₃M
M represents a cation 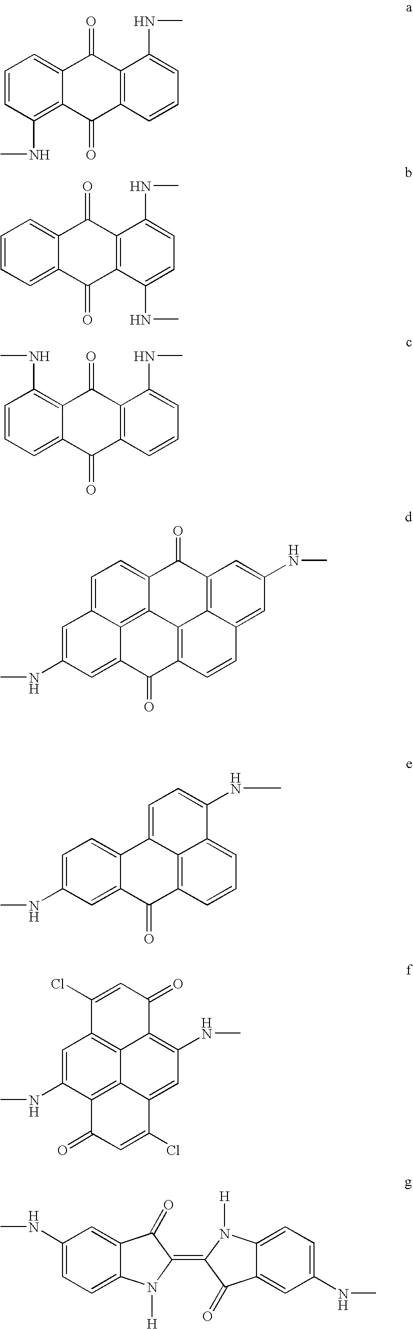 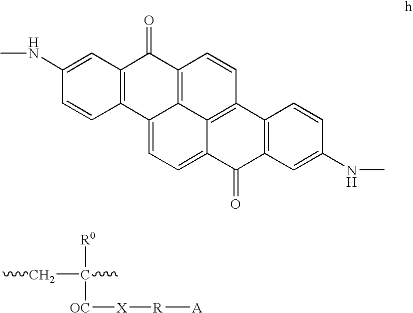
R represents 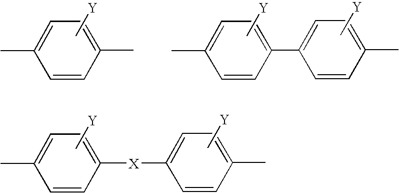
   (CH₂)₃, (CH₂)₆
X represents NH, O
Y represents H, CH₃, CH₃O, COOM, SO₃M
M represents a cation
R⁰ represents H, CH₃
A is any one of the following a, b, c, d, e, and f 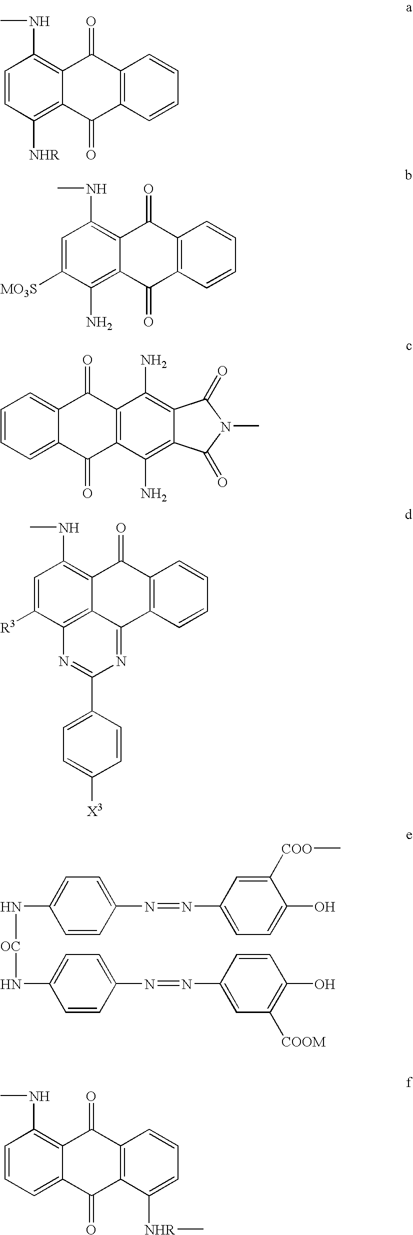
R³ represents H, Br, SO₃M
x³ represents H, SO₃M 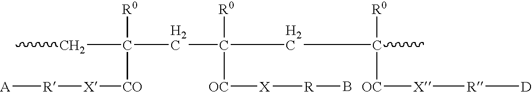
R represents 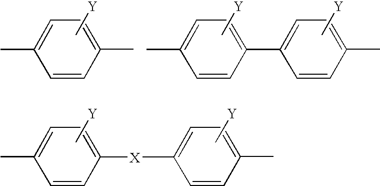
   (CH ₂)₃ or (CH₂)₆
X, X′, X″ represents NH, O
Y represents H, CH₃, CH₃O, COOM, SO₃M
M represents a cation
R⁰ represents H, CH₃
A, B and D are any one of the following a, b, c, d, e, and f 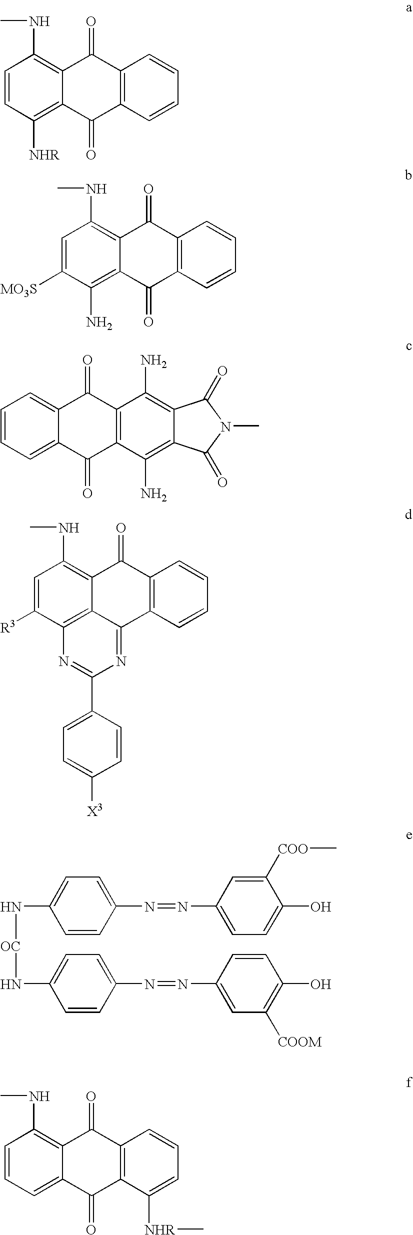
R³ represents H, Br, SO₃M
x³ represents H, SO₃M 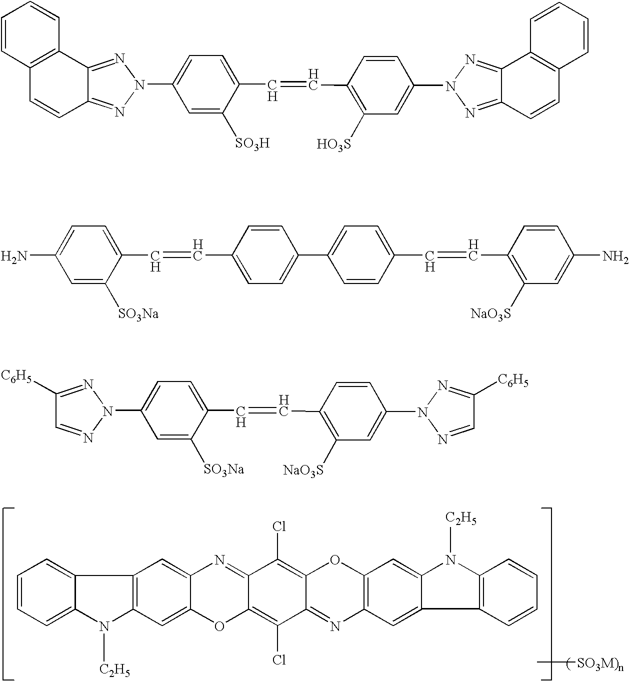
n is an integer of 2 to 4
M represents a cation 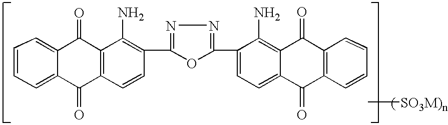
n is 2
M represents a cation 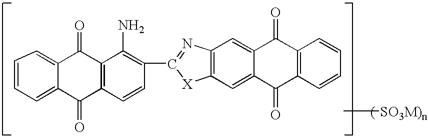
n is 2 or 3
M represents a cation 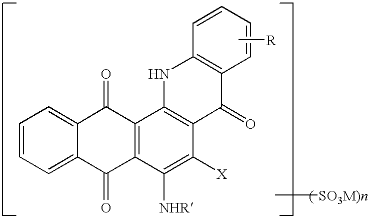
n is 2
M represents a cation
R, R′ represent H, Cl, alkyl group, alkoxy group

The alkyl group in the above mentioned chemical formulae preferably has 1 to 4 carbon atoms. The halogen in the above mentioned chemical formulae is preferably Cl or Br. Further, mentioned as the cation in the above mentioned chemical formulae are: H⁺, Li⁺, Na⁺, K⁺, Cs⁺ or NH₄⁺. These substances can be used by itself or in admixture of two or more kinds.

In the present invention, among the above, substances of the above mentioned chemical formulae I to V are suitably used.

The above mentioned tabular dye is not limited to those showing a lyotropic liquid crystal phase as described above, and may be that showing a thermotropic liquid crystal phase.

Further, the polarizing layer used in the present invention may contain liquid crystal materials in addition to the above mentioned tabular dyes. The reason for this is that, for example, even if the tabular dye is not easily aligned by concave portions of a resin layer, by allowing liquid crystal materials to be aligned along concave portions, the tabular dyes can be aligned along this alignment direction of the liquid crystal materials. As the above mentioned liquid crystal materials, liquid crystal materials that can be used generally in a polarizing layer can be used. A liquid crystal composition composed of the above mentioned liquid crystal materials and the tabular dyes may be that showing a lyotropic liquid crystal phase or that showing a thermotropic liquid crystal phase, and usually, those showing a thermotropic liquid crystal phase are used.

The thickness of a polarizing layer formed in the present invention differs depending on the kind of the above mentioned tabular dye, the intended transmittance of the polarizing plate, and the like. The thickness is usually in a range of 50 nm to 2000 nm, more preferably, 100 nm to 1000 nm.

A method for forming a polarizing layer is explained in a paragraph of “C. Method of manufacturing polarizing plate” described later. Therefore, explanations thereof are omitted here.

3. Base Material

Next, the base material used in the present invention is explained. The base material is not particularly limited as long as the above mentioned resin layer can be formed in the present invention. In the present invention, since the above mentioned polarizing layer is formed by utilizing the concave portions of the above mentioned resin layer, it is not necessary to orient the base material, and the base material is not limited. As a result, for example, base materials having various functions such as strength, durability and the like can also be used, and can be appropriately selected depending on the kind of the polarizing plate to be formed. The base materials having flexibility, for example, a resin film and the like, or ones having no flexibility, for example, a glass base material and the like can be used.

As described above, in the present invention, since the concave portions can be formed to form a resin layer by coating the curing resin composition on the base material and by sandwiching the curing resin composition between the base material and the concave portion forming substrate having convex portions, the polarizing plate can also be manufactured continuously by a roll-to-roll process. In this case, it is preferable that the above mentioned base material is a transparent resin film having flexibility and having a transmittance of 80% or more. As such resin film, films of cellulose based resins, norbornene based resins, cycloolefin based resins and the like, further, films of polycarbonate, polyarylate, polysulfone, polyether sulfone and the like, can be used.

Informing the above mentioned resin layer, when the curing resin composition is cured by, for example, irradiating with ultraviolet ray from the base material side, it is necessary that the above mentioned base material has ultraviolet ray permeability.

Further, when the polarizing plate of the present invention is used as a transmission type polarizing plate, a transparency is usually required to the base material. However, for example, when a reflection layer formed of a metal and like is formed on the surface of the base material to give a reflection type polarizing plate or semi-transmission type polarizing plate, a transparency is not necessarily required to the above mentioned base material.

The thickness of the base material used in the present invention differs depending on the kind and use of the polarizing plate. It can be usually in a range of 100 to 1000 μm.

To improve close adherence between the base material and the resin layer, the base material may be subjected to a surface treatment. Specifically, a glow discharge treatment, a corona discharge treatment, a UV treatment, a saponification treatment and the like can be used. Moreover, a primer layer may be formed on the base material. Further, for the purpose of protecting the base material from the curing resin composition, a primer layer (barrier layer) may be formed. As such a primer layer, for example, silane based coupling agents, titanium based coupling agents and the like can be listed.

Further, a functional layer may be formed on the above mentioned base material. The functional layer used in the present invention is not particularly limited as long as it is generally used in liquid crystal displays. For example, a color filter layer and the like are mentioned. The color filter layer is not particularly limited as long as it is generally used as a color filter layer for liquid crystal displays, and those using pigments and resins can be used. Further, a black matrix may be formed in between respective colors.

4. Polarization Plate

Next, the polarizing plate of the present invention is explained. The polarizing plate of the present invention is not particularly limited as long as the above mentioned resin layer is formed on the above mentioned base material, and the tabular dyes are aligned along a certain direction by concave portions on the surface of the resin layer, to form a polarizing layer.

The thickness of the polarizing plate of the present invention is appropriately selected depending on the used and kind of the polarizing plate, and usually, it can be in a range of 50 μm to 1000 μm.

In the present invention, the polarizing plate may be a reflection type polarizing plate, in which a reflection layer made of a metal and the like is formed on the above mentioned base material, or may be a semi-transmission reflection type polarizing plate, in which the above mentioned reflection layer is formed on the above mentioned base material so that it has a transparency to visible light to a certain extent.

Such a reflection layer, for example, can be formed of a metal of high reflectance such as aluminum, silver and the like by, for example, a vacuum vapor deposition method, a sputtering method, an ion plating method and the like. When the reflection type polarizing plate is formed, for example, its thickness can be usually in a range of 10 nm to 100 nm. And when the semi-transmittance reflection type polarizing plate is formed, the thickness can be usually in a range of 10 nm to 30 nm. When the reflection layer made of the above mentioned metal is formed, it is preferable to form a protective layer made of, for example, an acrylic resin, epoxy resin, polyester resin, urethane resin, alkyd resin and the like, to prevent deterioration of the above mentioned reflection layer. If necessary, a light scattering layer and the like may be formed.

B. Liquid Crystal Display

Next, the liquid crystal display of the present invention is explained. The liquid crystal display of the present invention is not particularly limited as long as it is formed by laminating the above mentioned polarizing plate and liquid crystal cell. For example, the above mentioned polarizing plate may be laminated on both surfaces of a liquid crystal cell, or the above mentioned polarizing plate may be laminated on one surface of a liquid crystal cell, as a front surface polarizing plate or rear surface polarizing plate. Further, when the liquid crystal cell is a plastic liquid crystal cell, in which two polymer films are placed facing each other, the above mentioned polarizing plate may be used as the polymer film constituting this liquid crystal film cell.

The liquid crystal display of the present invention can be that having small thickness because it uses the above mentioned polarizing plate, and it is preferable also from the standpoints of manufacturing efficiency and cost.

As the liquid crystal cell used in the present invention, those usually used in liquid crystal displays can be used.

C. Method of Manufacturing Polarizing Plate

Next, the method for manufacturing a polarizing plate of the present invention is explained.

The method for manufacturing a polarizing plate of the present invention comprises:

a resin layer forming process of forming a resin layer by carrying out: a coating process of coating a curing resin composition on a base material or on a concave portion forming substrate, having convex portions formed in a pattern on its surface; a disposing process of laminating the base material and the concave portion forming substrate with sandwiching the curing resin composition; a curing process of curing the curing resin composition to obtain a curing resin; and a concave portion forming process of forming the concave portion in a pattern by peeling the concave portion forming substrate from the curing resin composition or from the curing resin; and

a polarizing layer forming process of forming a polarizing layer by carrying out: a coated film forming process of forming a coated film by coating a polarizing layer forming coating solution, on the resin layer, comprising a tabular dye and aligning the tabular dye by the concave portions of the resin layer; a drying process of drying the coated film; and a fixing process of fixing the aligned condition of the tabular dye.

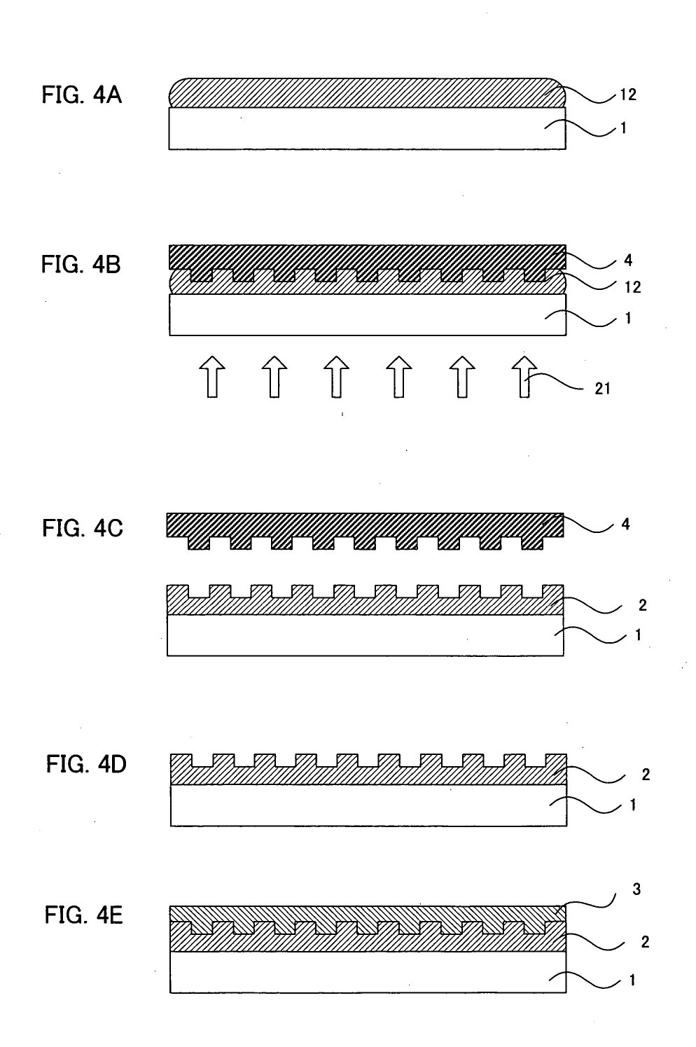

The method for manufacturing a polarizing plate of the present invention is explained referring to drawings. FIGS. 4A, 4B, 4C, 4D, and 4E are process views showing one example of the method for manufacturing a polarizing plate of the present invention. As shown in FIGS. 4A, 4B, 4C, 4D, and 4E, in the method for manufacturing a polarizing plate of the present invention, first, a curing resin composition 12 is coated on a base material 1 (FIG. 4A). The base material 1 and a concave portion forming substrate 4, having convex portions formed in a pattern, are laminated with sandwiching the curing resin composition 12 therebetween, and the curing resin composition 12 is cured by irradiating with an ultraviolet ray 21 (FIG. 4B). Further, the concave portion forming substrate 4 is peeled off (FIG. 4C), to form a resin layer 2 having concave portions (FIG. 4D). Thus, the resin layer forming process is carried out. Next, polarizing layer forming coating solution comprising the tabular dyes is coated on the above mentioned resin layer 2, the tabular dyes are aligned by the concave portions of the resin layer 2, and the aligned condition of the tabular dyes is fixed, to form a polarizing layer 3 (FIG. 4E). Thus, the polarizing layer forming process is carried out.

In the present invention, the resin layer, having concave portions formed in a pattern on its surface, is formed in the above mentioned resin layer forming process. Therefore, the above mentioned tabular dyes can be easily aligned along a certain direction by the pattern of the concave portions of the resin layer, to give a polarizing layer. By this, a polarizing plate can be manufactured efficiently without limitation of the kind and thickness of the base material.

The processes in the method for manufacturing a polarizing plate of the present invention are described, below.

1. Resin Layer Forming Process

First, the resin layer forming process in the present invention is explained. The resin layer forming process in the present invention comprises: a coating process of coating a curing resin composition on a base material or on a concave portion forming substrate, having convex portions formed in a pattern on its surface; a disposing process of laminating the base material and the concave portion forming substrate with sandwiching the curing resin composition; a curing process of curing the curing resin composition to obtain a curing resin; and a concave portion forming process of forming the concave portion by peeling the concave portion forming substrate from the curing resin composition or from the curing resin.

Each process in such a resin layer forming process is described, below.

(1) Coating Process

In the resin layer forming process in the present invention, first, a coating process of coating a curing resin composition on a base material or a concave portion forming substrate, having convex portions formed in a pattern on its surface, is carried out.

The curing resin composition, base material and the like, used in this process, are the same as those described in the above mentioned paragraph of “A. Polarizing plate”. Therefore, explanations thereof are not repeated here. The concave portion forming substrate and the method for coating a curing resin composition are described below.

(Concave Portion Forming Substrate)

First, the concave portion forming substrate used in this process is explained. The concave portion forming substrate used in this process has the convex portions formed in a pattern on its surface, and the shape and pattern of the convex portions are formed so that they are symmetry to the intended shape of the pattern of the concave portions of a resin layer.

The width, height and pattern shape of the convex portions correspond to the shape of concave portions formed on the resin layer described in the paragraph of the resin layer in “A. Polarizing plate” described above. Therefore, explanations thereof are not repeated here.

The kind and the like of such concave portion forming substrate is not particularly limited as long as a pattern as described above is formed thereon. It may be that having flexibility, for example, a resin film and the like, or that having no flexibility, for example, glass and the like. In the present invention, since the concave portion forming substrate is used repeatedly, materials having certain strength are suitably used. Specifically, a glass, a ceramic, a metal, a plastic and the like can be listed. Such a material is appropriately selected depending on a method for forming convex portions described later. Further, the above mentioned concave portion forming substrate is appropriately selected depending on a method for irradiating ultraviolet ray for curing the curing resin composition in the below mentioned curing process. That is, when the ultraviolet ray is irradiated from the side of the concave portion forming substrate, ultraviolet ray permeability is necessary. While the ultraviolet ray is irradiated from the base material side, there is no particular limitation.

The above mentioned concave portion forming substrate may be shifted by a cylindrical drum for convex-concave. Further, the concave portion forming substrate itself may constitute a cylindrical drum for convex-concave, that is, the convex portions may be formed on the surface of the cylindrical drum for convex-concave. The reason for this is that, by going through a roll-to-roll process, concave portions can be duplicated continuously on the base material, leading to an improvement of the manufacturing efficiency. By forming such an original plate of the concave portion forming substrate only for one time, a polarizing plate having an excellent polarization property can be manufactured in large amount. Therefore, manufacturing efficiency can be further improved.

As the method for forming such convex portions in a pattern, for example, a method for patterning glass, resin film or the like, a method, in which a photosensitive resin layer and the like is coated on a surface of glass and the like and patterning this photosensitive resin layer, and other methods, can be used. As a patterning method, generally used methods can be used. For example, a photolithography method, sputtering method, mechanical cutting method and the like are listed. Further, an oblique vapor deposition method, rubbing method and the like can also be used.

(Method of Coating Curing Resin Composition)

In this process, the curing resin composition 12 may be coated on, for example, the base material 1 as shown in FIG. 4A, or may be coated on coated concave portion forming substrate, though not shown in the figures. Further, the coating may also be carried out by fixing the base material and the concave portion forming substrate with a certain clearance, and pouring the curing resin composition therebetween.

As the method for coating the above mentioned curing resin composition, a spin coating method, a roll coating method, a printing method, a dip coating method, a curtain coating method (a die coating method) and the like can be listed.

It is preferable that the thickness of the coated curing resin composition is in a range of 0.1 to 30 μm, particularly in a range of 0.2 to 10 μm. The reason for this is that when the thickness of the curing resin composition is too small, there is a possibility that duplication of the concave portions on the curing resin composition is not carried out sufficiently. In contract, when the thickness is too large, it is difficult to decrease the thickness of the polarizing plate manufactured by the present invention, further, when the base material is a film, there is a possibility that the coated surface tends to be easily curled.

The above mentioned curing resin composition may be coated by the above mentioned method while controlling the coating amount so that the curing resin composition gives a desired thickness, or surplus curing resin composition may be removed after coating. As the method for removing surplus curing resin composition, a method for removal by using a roller, a method for scraping by using a doctor blade, and the like are listed. Such a process of removing surplus curing resin composition may be carried out after the coating process, or may be carried out after a disposing process described later.

(2) Disposing Process

Next, the disposing process in the resin layer forming process in the present invention is explained. The disposing process in the present invention is a process of laminating the above mentioned base material and the above mentioned concave portion forming substrate with sandwiching the above mentioned curing resin composition.

The method for disposing the above mentioned base material and concave portion forming substrate is not particularly limited as long as the coated curing resin composition is disposed so as to become in contact with the base material and the concave portion forming substrate. However, it is preferable that the curing resin composition is disposed so as to closely adhere to the base material. The reason for this is that since the resin layer, made of a curing resin obtained by curing the curing resin composition, is formed on the base material, it is preferable for the curing resin composition to be closely adhered to the base material. Moreover, it is preferable that the above mentioned base material and the above mentioned concave portion forming substrate are disposed with a certain clearance so that the curing resin composition will be of a desired thickness.

To improve the adherence between the above mentioned base material and the above mentioned curing resin composition, it is preferable to carry out a surface treatment on the base material. Specifically, a glow discharge treatment, a corona discharge treatment, an UV treatment, a saponification treatment and the like can be used. Moreover, a primer layer may be formed on the base material. Further, for the purpose of protecting the base material from the curing resin, a primer layer (a barrier layer) maybe formed. As such a primer layer, for example, silane based coupling agents, titanium based coupling agents and the like are listed.

(3) Curing Process

In the resin layer forming process in the present invention, a curing process, of curing the above mentioned curing resin composition to obtain the curing resin, is carried out.

The method for curing the above mentioned curing resin composition is appropriately selected depending on the kind of the curing resin composition. When the curing resin in the above mentioned curing resin composition is a thermosetting resin, curing can be carried out by leaving the composition for a predetermined time at normal temperature or being heated. When the curing resin in the above mentioned curing resin composition is an ultraviolet ray curing resin, curing can be carried out by irradiation with ultraviolet ray. In this case, it is necessary that either one of the base material or the concave portion forming substrate has ultraviolet ray permeability.

It is preferable that the thickness of the curing resin obtained by curing the curing resin composition is in a range of 0.1 to 30 μm, more preferably in a range of 0.2 to 10 μm. The reason for this is that when the thickness is larger than the above mentioned range, there is a possibility that it is difficult to decrease the thickness of the polarizing plate manufactured by the present invention. Also, when the thickness is smaller than the above mentioned range, toughness may be poor.

In the present invention, the curing process maybe carried out after the above mentioned coating process, after the above mentioned disposing process or during the concave portion forming process. That is, the curing resin composition may be cured after coating on the base material or on the concave portion forming substrate (after coating process), may be cured after disposing by laminating the base material and concave portion forming substrate with sandwiching the curing resin composition (after disposing process), or may be cured after peeling the concave portion forming substrate from the curing resin composition (during concave portion forming process). These embodiments are explained below.

(First Embodiment)

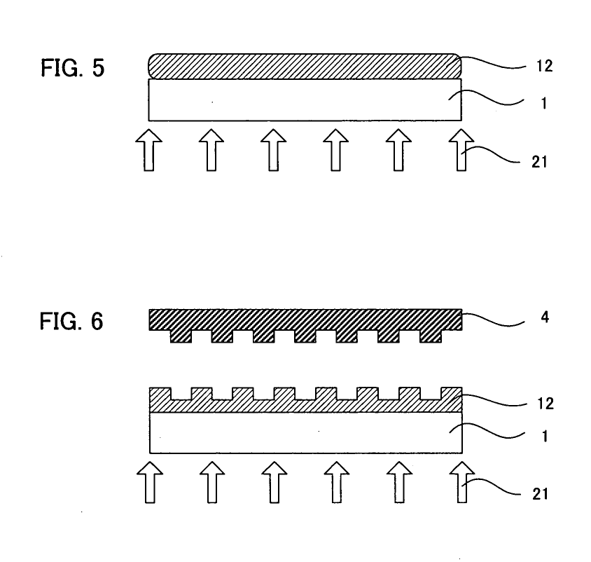

In the present invention, in a first embodiment of the curing process, the concave portion is formed by: coating the curing resin composition on the base material or on the concave portion forming substrate; curing the above mentioned curing resin composition by heating or irradiation with ultraviolet ray; disposing the base material and the concave portion forming substrate by laminating them with sandwiching the curing resin obtained by curing; and peeling the concave portion forming substrate from the above mentioned curing resin composition. In this embodiment, for example as shown in FIG. 5, the curing resin composition 12 is coated on the base material 1. Then, the above mentioned curing resin composition 12 is cured by irradiating with ultraviolet ray 21. In FIG. 5, the curing resin composition is coated on the base material 1. However, it may be coated also on the concave portion forming substrate.

In this case, regarding the direction of irradiation with ultraviolet ray for curing the above mentioned curing resin composition, irradiation may be carried out from the side of the base material or concave portion forming substrate, or may be from the side of the curing resin composition. However, when a curing resin composition is coated on the base material or concave portion forming substrate, and the curing resin composition is irradiated from the side of the base material or concave portion forming substrate, it is necessary that the base material or concave portion forming substrate has ultraviolet ray permeability.

Moreover, when the curing resin composition is coated on the base material and cured, since the concave portion forming substrate is placed on the surface of the curing resin obtained by curing to duplicate the concave portions, it is necessary that the curing resin has a predetermined viscosity even after curing. Therefore, it is preferable that the curing resin composition is not completely cured, and it may be cured again after the concave portion forming substrate is disposed on the surface of the curing resin, or after the concave portion forming substrate is peeled off from the curing resin.

(Second Embodiment)

In the present invention, in a second embodiment of the curing process, the concave portion is formed by: coating the curing resin composition on the base material or the concave portion forming substrate; disposing the base material and the concave portion forming substrate by laminating them with sandwiching the above mentioned curing resin composition; curing the above mentioned curing resin composition by heating or irradiation with ultraviolet ray; and peeling off the concave portion forming substrate from the curing resin obtained by curing. In this embodiment, for example as shown in FIG. 4B, the base material 1 and the concave portion forming substrate 4 are disposed by laminating them with sandwiching a curing resin composition 12. Then, the curing resin composition 12 is cured by irradiation with ultraviolet ray 21.

In this case, regarding the direction of irradiation with ultraviolet ray for curing the above mentioned curing resin composition, irradiation may be carried out from the side of the concave portion forming substrate or from the side of the base material. However, when irradiating from the side of the base material, it is necessary that the base material has ultraviolet ray permeability. And when irradiating from the side of the concave portion forming substrate, it is necessary that the concave portion forming substrate has ultraviolet ray permeability.

(Third Embodiment)

In the present invention, in a third embodiment of the curing process, the concave portion is formed by: coating the curing resin composition on the base material or the concave portion forming substrate; disposing the base material and concave portion forming substrate by laminating them with sandwiching the above mentioned curing resin composition; peeling the concave portion forming substrate from the above mentioned curing resin composition; and curing the above mentioned curing resin composition by heating or irradiating with ultraviolet ray. In this embodiment, for example as shown in FIG. 6, the concave portion forming substrate 4 is peeled off from the curing resin composition 12. Then, the curing resin composition 12 is cured by irradiation with ultraviolet ray 21.

In this case, regarding the direction of irradiation with energy ray for curing the above mentioned curing resin composition, irradiation may be carried out from the side of the curing resin composition or from the side of the base material. However, when irradiating from the side of the base material, it is necessary that the base material has ultraviolet ray permeability.

Moreover, since the curing resin composition is cured after peeling the concave portion forming substrate off from the curing resin composition, it is necessary that the curing resin composition maintains concave portions even after peeling the concave portion forming substrate off. Therefore, the curing resin composition may be previously processed to be a semi-cured condition before peeling the concave portion forming substrate off from the curing resin composition so that the curing resin composition has a predetermined viscosity.

(4) Concave Portion Forming Process

In the resin layer forming process in the present invention, a concave portion forming process, of forming the concave portion in a pattern by peeling the concave portion forming substrate from the curing resin composition or from the curing resin, is carried out. By this, for example as shown in FIG. 4C, the resin layer 2 having a pattern of concave portions, corresponding to the pattern of convex portions of the above mentioned concave portion forming substrate, can be formed.

The method for peeling the concave portion forming substrate from the above mentioned curing resin composition or the above mentioned curing resin is not particularly limited as long as the curing resin composition or curing resin is peeled from the concave portion forming substrate, is adhered closely to the base material, and the concave portions are formed.

In the present invention, the resin layer having the concave portion may be formed by duplicating the concave portions continuously on the base material by: shifting the concave portion forming substrate by a cylindrical drum for convex-concave; shifting the base material by a cylindrical drum for base material; laminating the base material and the concave portion forming substrate, on the above mentioned two cylindrical drums, with sandwiching the curing resin composition or the curing resin; and peeling the above mentioned concave portion forming substrate from the above mentioned curing resin composition or the above mentioned curing resin. Further, the above mentioned concave portion forming substrate may be the cylindrical drum for convex-concave. The reason for this is that, by going through a roll-to-roll process, duplication of the concave portions can be carried out continuously on the base material, to improve manufacturing efficiency. Moreover, by forming an original plate of such a concave portion forming substrate only for one time, a polarizing plate having an excellent polarization property can be manufactured in large amount.

2. Polarizing Layer Forming Process

Next, the polarizing layer forming process in the present invention is explained. The polarizing layer forming process in the present invention is a process of forming a polarizing layer by carrying out: a coated film forming process of forming a coated film by coating a polarizing layer forming coating solution, on the resin layer, comprising a tabular dye and aligning the tabular dye by the concave portions of the resin layer; a drying process of drying the coated film; and a fixing process of fixing the aligned condition of the tabular dye.

In the present invention, since the concave portions are formed in a pattern on the above mentioned resin layer, the tabular dyes can be aligned along a certain direction by this pattern of the concave portions.

Each process in such a polarizing layer forming process is described below.

(1) Coated Film Forming Process

The coated film forming process in the present invention is a process of forming a coated film by coating a polarizing layer forming coating solution, on the resin layer, comprising a tabular dye and aligning the tabular dye.

The polarizing layer forming coating solution used in this process comprises the tabular dyes. The tabular dye is the same as that described in the paragraph of the polarizing layer in “A. Polarizing plate” described above. Therefore, explanations thereof are not repeated here.

The solvent used in the above mentioned polarizing layer forming coating solution is appropriately selected depending on a substituent introduced into the above mentioned tabular dye. For example, when a hydrophilic group such as a sulfonic group and the like is introduced, water is used as the solvent. On the other hand, when a hydrophobic group such as a long chain alkyl group and the like is introduced, an organic solvent is used. As such an organic solvent, those generally used can be used. The above mentioned polarizing layer forming coating solution may comprise various additives such as surfactants and the like such as, for example, polyethylene glycol and the like, if necessary.

In the present invention, among the above, water based polarizing layer forming coating solution is preferable. The reason for this is that, as the tabular dye used in the present invention, those having a column structure, having a hydrophilic group and showing a lyotropic liquid crystal phase in an aqueous solution are preferably used.

The above mentioned polarizing layer forming coating solution may comprise a liquid crystal material in addition to the above mentioned tabular dye. The reason for this is that, for example, even if the tabular dyes are not easily aligned by concave portions of the resin layer, the liquid crystal material can be aligned along the concave portions of the resin layer, and the tabular dyes can be aligned along this alignment direction of the liquid crystal material. The liquid crystal material is the same as that described in the paragraph of the polarizing layer in “A. Polarizing plate” described above. Therefore, explanations thereof are not repeated here.

Such a method for coating polarizing layer forming coating solution is not particularly limited as long as the polarizing layer forming coating solution can be coated, and the above mentioned tabular dyes can be aligned along a certain direction by the pattern of the concave portions of the above mentioned resin layer. And a coating method applying no shearing stress is preferable. The reason for this is that when a coating method applying shearing stress is used, there is a possibility that the tabular dyes are aligned along the coating direction and are not easily aligned by the pattern of the concave portions of the above mentioned resin layer. As such a coating method applying no shearing stress, for example, a spray coating method, an inkjet method, a flexo printing method and the like are mentioned. Among the above, an inkjet method is preferably used.

(2) Drying Process

The drying process in the present invention is a process of drying the coated film formed in the above mentioned coated film forming process, and a process of drying the solvent contained in the above mentioned polarizing layer forming coating solution. In the present invention, a fixing process described later can be carried out smoothly by providing this drying process.

As the method for drying the solvent in the above mentioned polarizing layer forming coating solution, methods generally used for drying a solvent, for example, heat drying, drying at normal temperature, freeze drying, far infrared drying and the like can be used.

(3) Fixing Process

The fixing process in the present invention is a process of fixing the aligned condition of the above mentioned tabular dyes. In the present invention, by carrying out such a fixing process, the polarizing layer can be imparted with water resistance and heat resistance, and excellent alignment stability can be obtained without disturbance of the alignment property of the tabular dyes by use environments and the like of the polarizing plate manufactured in the present invention.

As the method for fixing the aligned condition of the tabular dye used in the present invention, a method for cross-linking the tabular dyes can be used. This method for cross-linking the tabular dyes differs depending on the above mentioned substituent introduced into the tabular dye.

When the above mentioned tabular dye has a hydrophilic group such as a sulfonic group and the like, a cross-linking method, in which this hydrophilic group is treated to be hydrophobic, is used. When the hydrophilic group on the above mentioned tabular dye is treated to be hydrophilic, cross-linking is formed between adjacent tabular dyes, and the aligned condition of the tabular dyes is fixed. When the above mentioned tabular dye shows a lyotropic liquid crystal phase in an aqueous solution, if the above mentioned hydrophobic treatment is not carried out, water resistance is poor, the aligned condition tends to be disturbed by humidity in air and the like, causing instability, in some cases.

The hydrophobic treatment solution used in the above mentioned hydrophobic treatment is not particularly limited as long as the hydrophilic group can be treated to be hydrophobic by the solution. Though it differs depending on the hydrophilic group on the tabular dye used, those can form cross-linking between adjacent tabular dyes are preferable. For example, an aqueous solution of a salt of a bivalent metal can be used. As the bivalent metal, magnesium, calcium, barium and the like can be mentioned. Specifically, an aqueous barium chloride solution, aqueous magnesium chloride solution, aqueous calcium chloride solution and the like can be used.

A mechanism of cross-linking of adjacent tabular dyes is as described below. For example, when the tabular dye has a SO₃Na group and an aqueous barium chloride solution is used for the hydrophobic treatment, since a SO₃ ion of a SO₃Na group in the tabular dye and a Ba ion in an aqueous barium chloride solution are bonded, adjacent tabular dyes are cross-linked and the aligned condition is fixed. That is, since adjacent tabular dyes are cross-linked in a condition that the tabular dyes are laminated with their normal line directions facing to a certain direction, a column structure is fixed.

The method of the hydrophobic treatment is not particularly limited as long as the above mentioned hydrophilic substituent can be made hydrophobic. A method, in which the above mentioned hydrophobic treatment solution is coated after drying the above mentioned polarizing layer forming coating solution, a method of immersing into the above mentioned hydrophobic treatment solution and the like can be listed. After coating or immersing of this hydrophobic treatment solution, cleaning and drying can be carried out to give a polarizing layer.

On the other hand, when the above mentioned tabular dye has a hydrophobic group such as a long chain alkyl group and the like, for example, a cross-linking method, in which the aligned condition is fixed by introducing a polymerizable group into a core portion or into a part of an alkyl side chain of the tabular dye, polymerizing this polymerizable group to cross-link the tabular dye in a form of line or a network, is used.

Further, when the above mentioned polarizing layer forming coating solution contains the above mentioned liquid crystal material, the aligned condition of the tabular dyes can be fixed also by polymerizing this liquid crystal material. In this case, it is necessary that the above mentioned liquid crystal material has a polymerizable group.

3. Others

In the present invention, it is preferable that after the above mentioned resin layer forming process, a hydrophilic treatment process of making the surface of the resin layer having the concave portions formed thereon hydrophilic, is carried out. The reason for this is that, when the resin layer forming process as described above is carried out, the surface of the formed resin layer usually shows high water repellency, and there is a possibility of poor alignment of the liquid crystal. The hydrophilic treatment method is the same as described in the column of “A. Polarizing plate” described above. Therefore, explanations thereof are not repeated here.

The present invention is not limited to the above mentioned embodiments. The above mentioned embodiments are only examples, and any embodiments having substantially the same constitution and exhibiting the same functions and effects as the technological idea described in claims of the present invention are included in the technological range of the present invention.

### EXAMPLES

The present invention will be specifically explained by way of examples.

### (Example 1)

On a cleaned glass substrate, a UV curing type acrylate resin having the following composition was spin coated, and an original plate having convex-concave formed by an electron beam drawing method was superimposed on this, and a load of 100 kg was applied to this for 1 minute. Under this condition, UV light was irradiated at 100 mJ/cm², further the original plate was peeled, then, UV light was irradiated at 3000 mJ/cm², to form a pattern of concave portions or convex portions having a width of the concave portion of 1 μm, a pitch of the concave portion of 2 μm, and a depth of the concave portion of 0.2 μm. By carrying out a plasma treatment on this, a hydrophilic treatment of the surface was carried out.

Along the groove direction of the pattern of concave portions or convex portions thus formed, an aqueous solution containing a dye having a tabular structure (LCPN013; manufactured by Optiva) was coated by using a Meyer bar, dried, and then, immersed in a 15 wt % aqueous barium chloride solution for about 1 second. Further, this was cleaned, and dried again to obtain a polarizing plate of 300nm. The degree of polarization thereof was measured, and it was 88%.

<Composition of UV curing type acrylate resin>

| | |
|---|---|
| Goshellac UV-7500B (manufactured by The Nippon | 40 parts by weight |
| Synthetic Chemical Industry Co., Ltd.) | |
| 1,6-hexanedioldiacrylate (manufactured by | 35 parts by weight |
| NIPPON KAYAKU CO., LTD.) | |
| pentaerythritol triacrylate (manufactured by | 21 parts by weight |
| TOAGOSEI Co., Ltd.) | |
| 1-hydroxycyclohexylphenylketone (manufactured | 2 parts by weight |
| by Chiba Geigy) | |
| benzophenone (manufactured by NIPPON | 2 parts by weight |
| KAYAKU CO., LTD.) | |

### (Example 2)

A pattern of concave portions or convex portions was formed in the same manner as in Example 1 except that the shape was the width of the concave portion of 0.2 μm, the pitch of the concave portion of 0.4 μm, and the depth of the concave portion of 0.2 μm, and by carrying out the plasma treatment on this, a surface hydrophilic treatment was carried out.

Along the groove direction of the pattern of concave portions or convex portions thus formed, an aqueous solution containing a dye having a tabular structure (N015; manufactured by Optiva) was coated by using an inkjet, dried, and then, immersed in a 15 wt % aqueous barium chloride solution for about 1 second. Further, this was cleaned, and dried again to obtain a polarizing plate of 300 nm. The degree of polarization thereof was measured, and it was 98%.

### (Comparative Example 1)

An aqueous solution containing a dye having a tabular structure (LCPN013; manufactured by Optiva) was coated by using a Meyer bar on a cleaned glass substrate, dried, and then, immersed in a 15 wt % aqueous barium chloride solution for about 1 second. Further, this was cleaned, and dried again to obtain a polarizing plate of 300 nm. The degree of polarization thereof was measured, and it was 83%.

### (Comparative Example 2)

An aqueous solution containing a dye having a tabular structure (N015; manufactured by Optiva) was coated by using a Meyer bar on a cleaned glass substrate, dried, and then, immersed in a 15 wt % aqueous barium chloride solution for about 1 second. Further, this was cleaned, and dried again to obtain a polarizing plate of 300 nm. The degree of polarization thereof was measured, and it was 93%.

1. A polarizing plate comprising: a base material; a resin layer formed on the base material and having concave portions or convex portions formed in a pattern on its surface; and a polarizing layer formed on the resin layer and comprising a tabular dye.

2. The polarizing plate according to claim 1, wherein the tabular dye is a dye selected from a group consisting of an anthraquinone based dye, a phthalocyanine based dye, a porphyrin based dye, a naphthalocyanine based dye, a quinacridone based dye, a dioxazine based dye, an indanethrene based dye, an acridine based dye, a perylene based dye, a pyrazolone based dye, an acridone based dye, a pyranthrone based dye and an isoviolanthrone based dye.

3. The polarizing plate according to claim 1, wherein the tabular dyes form a column structure, which is a lamination of the tabular dyes whose normal line directions are faced to a certain direction of the base material, and
the column structure is aligned along the concave portion of the resin layer.

4. The polarizing plate according to claim 1, wherein the tabular dye shows a lyotropic liquid crystal phase in a solution.

5. The polarizing plate according to claim 1, wherein a hydrophilic treatment is performed on a surface of the resin layer.

6. A liquid crystal display obtained by laminating the polarizing plate according to claim 1 and a liquid crystal cell.

7. A method for manufacturing a polarizing plate comprising a resin layer forming process of forming a resin layer by carrying out: a coating process of coating a curing resin composition on a base material or on a concave portion forming substrate, having convex portions formed in a pattern on its surface; a disposing process of laminating the base material and the concave portion forming substrate with sandwiching the curing resin composition; a curing process of curing the curing resin composition to obtain a curing resin; and a concave portion forming process of forming the concave portion in a pattern by peeling the concave portion forming substrate from the curing resin composition or from the curing resin; and
a polarizing layer forming process of forming a polarizing layer by carrying out: a coated film forming process of forming a coated film by coating a polarizing layer forming coating solution, on the resin layer, comprising a tabular dye and aligning the tabular dye by the concave portions of the resin layer; a drying process of drying the coated film; and a fixing process of fixing the aligned condition of the tabular dye.

8. The method for manufacturing a polarizing plate according to claim 7, wherein the tabular dyes form a column structure, which is a lamination of the tabular dyes whose normal line directions are faced to a certain direction of the base material,
show a lyotropic liquid crystal phase in the polarizing layer forming coating solution, and
the column structure is aligned along the concave portion of the resin layer.

9. The method for manufacturing a polarizing plate according to claim 7, wherein a coating method, in which a shearing stress is not applied to the polarizing layer forming coating solution, is used in the coated film forming process in the polarizing layer forming process.

10. The method for manufacturing a polarizing plate according to claim 7, wherein a method for cross-linking the tabular dye is used in the fixing process of the polarizing layer forming process.

11. The method for manufacturing a polarizing plate according to claim 7, wherein a hydrophilic treatment process of making the surface of the resin layer having concave portions formed thereon hydrophilic, is carried out after the resin layer forming process.
